(19) United States
(12) Patent Application Publication
(10) Pub. No.: US 2013/0174811 A1
(43) Pub. Date: Jul. 11, 2013

(54) FUEL SUPPLY DEVICE FOR INTERNAL COMBUSTION ENGINE

(71) Applicants: Taichi Nishimura, Toyota-shi (JP); Rihito Kaneko, Miyoshi-shi (JP)

(72) Inventors: Taichi Nishimura, Toyota-shi (JP); Rihito Kaneko, Miyoshi-shi (JP)

(73) Assignee: TOYOTA JIDOSHA KABUSHIKI KAISHA, Toyota-shi, Aichi-ken (JP)

(21) Appl. No.: 13/822,207

(22) PCT Filed: Apr. 20, 2011
(86) PCT No.: PCT/JP2011/059679

§ 371 Date: Mar. 11, 2013

(51) Int. Cl. F02M 69/04

(52) U.S. Cl. CPC F02M 69/04
USPC 123/472

(57) ABSTRACT

A temperature reduction control for reducing the temperature of an injector is performed through first to third fuel supply control routines executed by an electronic control device. When the temperature of the injector is reduced by the execution of the temperature reduction control, heat transfer to the vicinity of the nozzle of the injector is reduced. Since the vicinity of the nozzle of the injector is less likely to be placed in a high-temperature environment by in accordance with reduction in heat transfer to the vicinity of the nozzle of the injector, the formation of deposit around the nozzle of the injector is suppressed.

This is a 371 national phase application of PCT/JP2011/059679 filed 20 Apr. 2011, the contents of which are incorporated herein by reference.

### FIELD OF THE INVENTION

The present invention relates to a fuel supply device for an internal combustion engine.

### BACKGROUND OF THE INVENTION

An internal combustion engine mounted in a vehicle such as an automobile includes an injector for injecting fuel into an intake port and a fuel supply device for supplying fuel adjusted to a feed pressure to the injector.

In the above injector, fuel and exhaust gas flowing back from a combustion chamber to the intake port adheres around the nozzle of the injector. If the vicinity of the nozzle to which the fuel and the exhaust gas adhere is placed in a high-temperature environment, deposit is formed, for example, by the burning of fuel and exhaust gas adhering around the nozzle. If the deposit is formed around the nozzle of the injector, the opening area of the nozzle may be made smaller by that deposit and the flow rate of fuel passing through the nozzle of the injector may decrease.

Thus, as disclosed in Patent Document 1, fuel may be injected from an injector with an increased feed pressure with the intention to remove the deposit formed around the nozzle. In this case, the flow velocity of the fuel passing through the nozzle of the injector is increased and the deposit around the nozzle is blown off and removed by that fuel. Thus, reduction in the opening area of the nozzle by the deposit is suppressed.

### PRIOR ART DOCUMENT

### Patent Document

Patent Document 1: Japanese Laid-Open Patent Publication No. 2007-32786 (Paragraphs [0049], [0052], [0073], [0074], and FIGS. 4, 7 and 8)

### SUMMARY OF THE INVENTION

By injecting fuel from the injector with the feed pressure increased as in Patent Document 1, the deposit accumulated around the nozzle of this injector is removed. However, even if the fuel is injected from the injector with the feed pressure increased as described above, the vicinity of the nozzle of the injector is inevitably placed in a high-temperature environment, wherefore the formation of deposit around the nozzle cannot be suppressed.

Accordingly, it is an objective of the present invention to provide a fuel supply device for an internal combustion engine capable of suppressing the formation of deposit around the nozzle of an injector for injecting fuel into an intake port.

According to one aspect of the present invention, when the temperature of an intake port becomes higher than a reference value or when the temperature of an injector for injecting fuel into the intake port becomes higher than a reference value, a temperature reduction control for reducing the temperature of the injector is performed as a control in supplying fuel adjusted to a feed pressure to the injector. Since the vicinity of a nozzle of the injector is exposed to heat from the intake port when the temperature of the intake port increases, the vicinity of the nozzle of the injector is placed in a high-temperature environment. Further, the vicinity of the nozzle of the injector is placed in a high-temperature environment also when the temperature of the injector increases and heat of the injector itself is transferred to the vicinity of the nozzle. If the temperature of the injector is reduced by performing the above temperature reduction control under these conditions, heat of the injector itself is less likely to be transferred to the vicinity of the nozzle and the vicinity of the nozzle is less likely to be placed under a high-temperature condition by that much. Therefore, the formation of deposit around the nozzle is suppressed.

According to one aspect of the present invention, when the valve overlap between an intake valve and an exhaust valve of an internal combustion engine becomes larger than a determination value, a temperature reduction control for reducing temperature of an injector is performed as a control in supplying fuel adjusted to a feed pressure to the injector for injecting fuel into an intake port. When the valve overlap between the intake valve and the exhaust valve becomes equal to or larger than the determination value, the amount of exhaust gas flowing back from a combustion chamber to the intake port increases and the temperature of the intake port and that of the injector tend to increase due to heat of the exhaust gas. Since the vicinity of a nozzle of the injector is exposed to heat from the intake port when the temperature of the intake port increases, the vicinity of the nozzle of the injector is placed in a high-temperature environment. Further, the vicinity of the nozzle of the injector is placed in a high-temperature environment also when the temperature of the injector increases and heat of the injector itself is transferred to the vicinity of the nozzle. If the temperature of the injector is reduced by performing the above temperature reduction control under these conditions, the vicinity of the nozzle is less likely to be placed under a high-temperature condition by in accordance with the reduction in heat transfer from the injector itself to the vicinity of the nozzle. Therefore, the formation of deposit around the nozzle is suppressed.

According to one aspect of the present invention, a temperature reduction control for reducing temperature of an injector is performed as a control in supplying fuel adjusted to a feed pressure to the injector for injecting fuel into an intake port prior to initiation of a stopping process of an internal combustion engine. Immediately after the stopping process of the internal combustion engine is completed, the engine temperature further increases since the cooling function by cooling water of the engine does not work with a high engine temperature maintained. At this time, heat of the internal combustion engine itself is transferred to the intake port and the injector, whereby the temperature of the intake port and that of the injector tend to increase. Since the vicinity of a nozzle of the injector is exposed to heat from the intake port when the temperature of the intake port increases, the vicinity of the nozzle of the injector is placed in a high-temperature environment. Further, the vicinity of the nozzle of the injector is placed in a high-temperature environment also when the temperature of the injector increases and heat of the injector itself is transferred to the vicinity of the nozzle. However, the temperature of the injector is reduced through the execution of the above temperature reduction control before the stopping operation of the internal combustion engine, which is a cause of these circumstances, is initiated. If the temperature of the injector is reduced in this way, heat of the injector itself is less likely to be transferred to the vicinity of the nozzle and the vicinity of the nozzle is less likely to be placed under a high-temperature condition by that much when the engine temperature increases immediately after the stopping operation of the internal combustion engine is completed. As a result, the formation of deposit around the nozzle of the injector immediately after the stopping operation of the internal combustion engine is completed is suppressed.

In the above temperature reduction control, specifically, the feed pressure may be reduced in supplying the fuel adjusted to the feed pressure to the injector or to increase a fuel injection time of the injector.

In the case of reducing the feed pressure as described above, the particle size of atomized fuel injected from the nozzle of the injector increases due to reduction of the feed pressure, wherefore particles of the atomized fuel are more likely to reach the intake port. When the particles of the atomized fuel reach the intake port and are vaporized there, heat from the intake port is absorbed through latent heat of vaporization of the fuel, whereby the temperature of the intake port is effectively reduced. As a result, heat of the intake port is less likely to be transferred to the injector, and the temperature of the injector is reduced, accordingly.

Further, in the case of increasing the fuel injection period as described above, the fuel passes through the injector over a longer period in injecting the fuel from the injector and the injector is effectively cooled by that fuel. The temperature of the injector is reduced through such cooling of the injector by the fuel.

An execution condition of the above temperature reduction control is preferably that at least one of parameters including a cooling water temperature, a rotation speed and a load of the internal combustion engine becomes equal to or higher than a determination value set for each of the parameters. When the parameters such as the cooling water temperature, the rotation speed and the load of the internal combustion engine are high values, the temperature of the injector tends to increase. Thus, by performing the temperature reduction control when the above execution condition is met, the temperature of the injector can be reduced in a situation where the temperature of the injector tends to increase.

### BRIEF DESCRIPTION OF THE DRAWINGS

FIG. 1 is a schematic diagram entirely showing an engine to which a fuel supply device of one embodiment of the present invention is applied;

FIG. 2 is a graph showing a relationship between feed pressure and fuel injection time;

FIG. 3 is an enlarged view around an intake port showing a fuel injection mode of an injector;

FIG. 4 is an enlarged view around the intake port showing a fuel injection mode of the injector;

FIG. 5 is a graph showing temperature changes in the injector and the intake port;

FIG. 6 is a graph showing temperature changes in the injector and the intake port;

FIG. 7 is a flowchart showing an execution procedure of a fuel supply control;

FIG. 8 is a flowchart showing an execution procedure of the fuel supply control;

FIG. 9 is a flowchart showing an execution procedure of the fuel supply control;

FIG. 10 is a graph showing temperature changes in the intake port after an engine stopping operation is completed; and

FIG. 11 is a graph showing temperature changes in the injector after the engine stopping operation is completed.

### DETAILED DESCRIPTION OF THE PREFERRED EMBODIMENTS

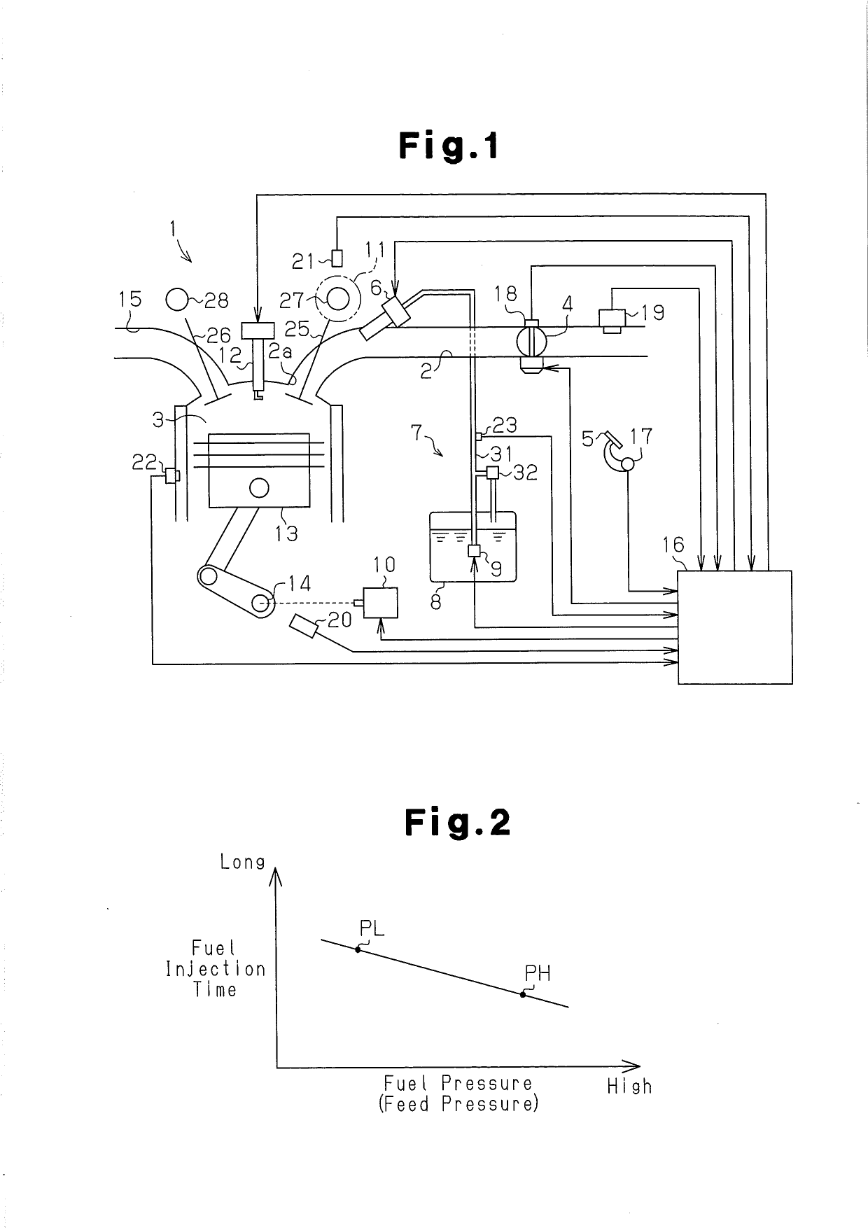

Hereinafter, a fuel supply device of an automotive engine according to one embodiment of the present invention will be described with reference to FIGS. 1 to 11.

A throttle valve 4, which is opened and closed to adjust the amount of air taken into a combustion chamber 3 (intake air amount), is provided in an intake passage 2 of an engine 1 shown in FIG. 1. The opening degree of this throttle valve 4 (throttle opening degree) is adjusted according to the depression amount (accelerator operation amount) of an accelerator pedal 5 depressed by the driver of an automobile. Further, the engine 1 includes an injector 6 for injecting fuel toward an intake port 2a of the combustion chamber 3 from the intake passage 2 and a fuel supply device 7 for supplying the fuel adjusted to a feed pressure to that injector 6.

The fuel supply device 7 includes a feed pump 9 for drawing fuel stored in the fuel tank 8, a fuel pipe 31 for feeding the fuel drawn by the feed pump 9 to the injector 6, and a pressure regulator 32 for preventing an excessive increase of the pressure of the fuel in the fuel pipe 31. In such a fuel supply device 7, the pressure of the fuel in the fuel pipe 31 is adjusted to the feed pressure through a drive control of the feed pump 9.

In the engine 1, an air-fuel mixture composed of the fuel injected from the injector 6 and air flowing in the intake passage 2 is charged into the combustion chamber 3 and this air-fuel mixture is ignited by a spark plug 12. When the ignited fuel-air mixture is combusted, a piston 13 is reciprocated by combustion energy and a crankshaft 14 rotates. On the other hand, the air-fuel mixture after combustion is fed as exhaust gas to an exhaust passage 15. A starter 10 for forcibly rotating (cranking) the crankshaft 14 when the engine 1 is started is connected to the crankshaft 14.

Communication and interruption between the combustion chamber 3 and the intake passage 2 in the engine 1 are effected by opening and closing an intake valve 25. Further, communication and interruption between the combustion chamber 3 and the exhaust passage 15 in the engine 1 are effected by opening and closing an exhaust valve 26. The intake valve 25 and the exhaust valve 26 are opened and closed according to the rotation of an intake camshaft 27 and an exhaust cam shaft 28, to which the rotation of the crankshaft 14 is transmitted.

The engine 1 includes a variable valve timing mechanism 11 provided on the intake camshaft 27 as a variable valve mechanism for varying valve characteristics (opening/closing characteristics) of the intake valve 25. This variable valve timing mechanism 11 is driven to change the relative rotational phase (valve timing of the intake valve 25) of the intake camshaft 27 with respect to the crankshaft 14. By driving such a variable valve timing mechanism 11, the valve opening timing and the valve closing timing of the intake valve 25 are both advanced or retarded with the valve opening period (operation angle) of the intake valve 25 kept constant. If the valve opening timing and the valve closing timing of the intake valve 25 are both advanced or retarded in this way, the valve overlap between the intake valve 25 and the exhaust valve 26 (period during which the intake valve 25 and the exhaust valve 26 are both open) increases and decreases.

An electronic control device 16 for performing various operation controls of the engine 1 is mounted in the automobile. The electronic control device 16 includes a CPU for performing various arithmetic processing relating to the above controls, a ROM storing programs and data necessary for the controls, a RAM for temporarily storing computational results and the like of the CPU, input/output ports for input/output of signals to and from the outside, and the like.

Various sensors and the like listed below are connected to the input ports of the electronic control device 16: An accelerator position sensor 17 for detecting an accelerator operation amount;

A throttle position sensor 18 for detecting the throttle opening degree;

An air flow meter 19 for detecting the amount of air passing through the intake passage 2 (intake air amount of the engine 1);

A crank position sensor 20 for outputting a signal corresponding to the rotation of the crankshaft 14;

A cam position sensor 21 for outputting a signal corresponding to the rotational position of the intake camshaft 27 based on the rotation of the intake camshaft 27;

A water temperature sensor 22 for detecting a cooling water temperature of the engine 1; and

A pressure sensor 23 for detecting the pressure (feed pressure) of the fuel in the fuel pipe 31.

Further, drive circuits and the like for various devices such as the throttle valve 4, the injector 6, the feed pump 9, the starter 10 and the spark plug 12 are connected to the output ports of the electronic control device 16.

The electronic control device 16 grasps engine operating conditions such as an engine speed, and an engine load based on signals input from the above various sensors and the like, and outputs command signals to the drive circuits for the various devices such as the throttle valve 4, the injector 6, the feed pump 9, the starter 10, the variable valve timing mechanism 11, and the spark plug 12 based on the grasped engine operating conditions. In this way, various operation controls of the engine 1 such as a throttle opening control, a fuel injection control of the engine 1, a pressure control for the fuel supplied to the injector 6 (fuel pressure control), an ignition timing control of the engine 1, a valve timing control of the intake valve 25, and a start control of the engine 1 are performed through the electronic control device 16.

The above engine speed is obtained based on a detection signal from the crank position sensor 20. Further, the engine load is calculated from a parameter corresponding to the intake air amount of the engine 1 and the engine speed. The parameter corresponding to the intake air amount may be an actual measurement value of the intake air amount of the engine 1 obtained based on a detection signal from the air flow meter 19, a throttle opening degree obtained based on a detection signal from the throttle position sensor 18, an accelerator operation amount obtained based on a detection signal from the accelerator position sensor 17 or the like.

In this automobile, an intermittent operation of automatically stopping and restarting the engine 1 depending on the state of the automobile is performed to improve fuel economy of the engine 1. Stop conditions for the engine 1 during the intermittent operation of the engine include a condition that the warm-up of the engine 1 has been completed and a condition that there is no output request for the engine 1. When the stop conditions for the engine 1 are met during the intermittent operation of the engine 1, the engine 1 is automatically stopped. Further, if the above stop conditions are no longer met in a state where the engine 1 is automatically stopped during the intermittent operation of the engine 1, the engine 1 is restarted.

The pressure of the fuel supplied to the injector 6, i.e. the pressure in the fuel pipe 31 (feed pressure) is adjusted in consideration of the suppression of formation of fuel vapor (vapor) in the fuel pipe 31. Specifically, as the temperature around the fuel pipe 31 inferred from the engine operating conditions increases, and vapor is more likely to be formed in the fuel pipe 31, a target value of the feed pressure is set to be higher so as to be able to suppress the formation of vapor. Then, the feed pump 9 is driven and controlled so that the feed pressure detected by the pressure sensor 23 reaches the above target value.

Further, a fuel injection amount control performed as one of fuel injection controls of the engine 1 is achieved by obtaining an injection amount command value Qfin based on the engine operating conditions such as the engine speed and the engine load and causing the injector 6 to inject the amount of fuel corresponding to the injection amount command value Qfin. Specifically, a fuel injection period of the injector 6 necessary to inject the amount of fuel corresponding to the injection amount command value Qfin from the injector 6 under the feed pressure detected by the pressure sensor 23 is obtained. Then, by opening the injector 6 for that fuel injection period, the amount of fuel corresponding to the injection amount command value Qfin is injected from the injector 6. The relationship between the feed pressure and the fuel injection period is a relationship, for example, shown by a solid line in FIG. 2 under a condition that the injection amount command value Qfin is constant. As is understood from FIG. 2, under the condition that the injection amount command value Qfin is constant, the fuel injection period becomes shorter as the feed pressure increases and, on the other hand, the fuel injection period becomes longer as the feed pressure decreases.

In the injector 6, the fuel and the exhaust gas flowing back from the combustion chamber 3 to the intake port 2a adhere around the nozzle of the injector 6. If the vicinity of the nozzle to which the fuel and the exhaust gas adhere is placed in a high-temperature environment, deposit is formed, for example, by the burning of the fuel and the exhaust gas adhering around the nozzle. To suppress the formation of the deposit around the nozzle of the injector 6, a temperature reduction control for reducing the temperature of the injector 6 is performed as a control for supplying the fuel to the injector 6 (fuel supply control) through the electronic control device 16 functioning as a controller. When the temperature of the injector 6 is reduced by performing this temperature-reduction control, the vicinity of the nozzle is less likely to be placed in a high-temperature environment in accordance with reduction in heat transfer from the injector 6 to the vicinity of the nozzle. Therefore, the formation of deposit around the nozzle is suppressed.

In the above temperature reduction control, specifically, the feed pressure is reduced and the fuel injection period in the injector 6 is increased in supplying the fuel adjusted to the feed pressure to the injector 6.

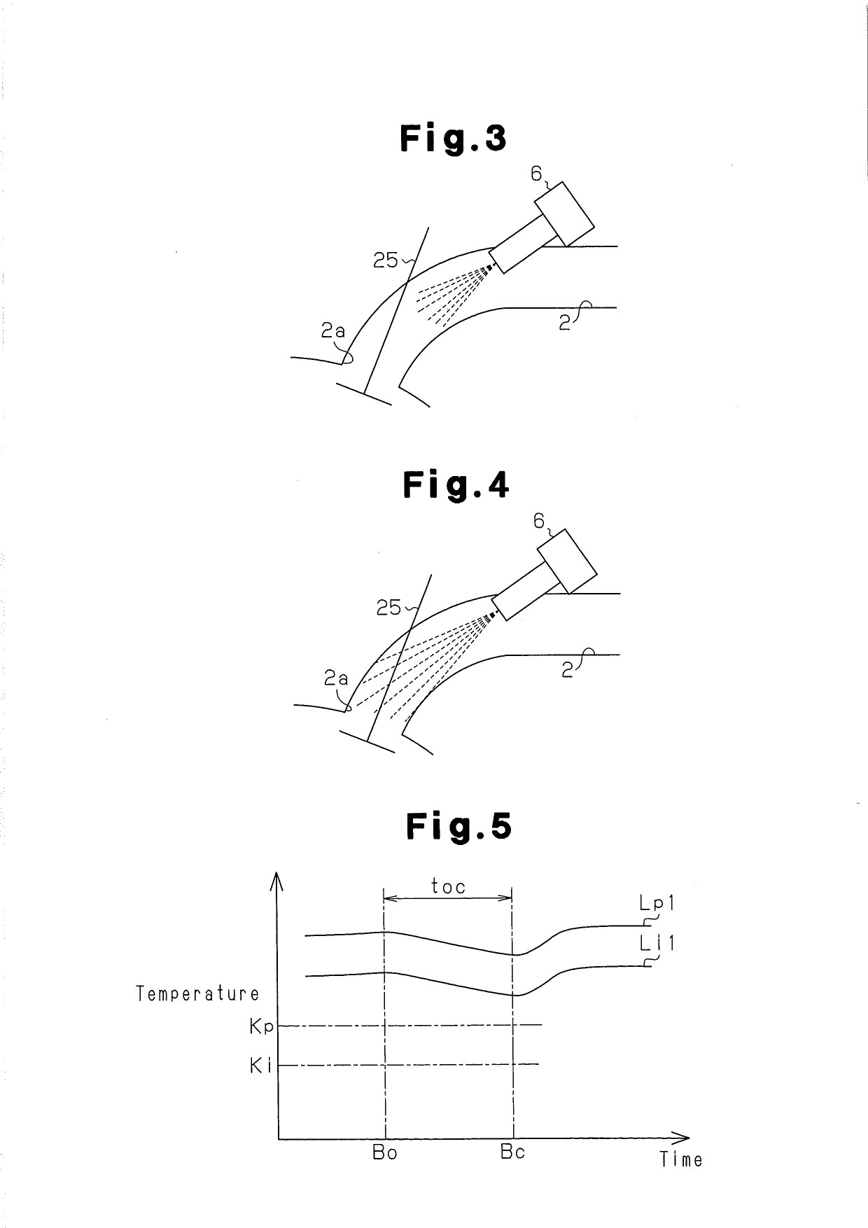

The feed pressure is adjusted, for example, to a point PH of FIG. 2 in a normal feed pressure control for driving and controlling the feed pump 9 so that the feed pressure reaches the target value, whereas the feed pressure is adjusted to a value lower than the above point PH, for example, a point PL of FIG. 2 in reducing the feed pressure in the above temperature reduction control. In the case of adjusting the feed pressure through the normal feed pressure control, atomization of the fuel injected from the nozzle of the injector 6 is promoted, thereby reducing the particle size of the atomized fuel. If the particle size of the fuel injected from the injector 6 becomes smaller in this way, the weight of each particle of the fuel becomes smaller. Thus, it becomes more difficult for the fuel particles to reach the intake port 2a as shown in FIG. 3. On the other hand, as the feed pressure is reduced through the temperature reduction control, the particle size of the atomized fuel injected from the nozzle of the injector 6 becomes larger and, hence, the weight of each particle of the fuel becomes larger. Thus, it becomes easier for the fuel particles to reach the intake port 2a as shown in FIG. 4. If the particles of the atomized fuel reach the intake port 2a and are vaporized there, heat from the intake port 2a is absorbed through latent heat of vaporization of the fuel, whereby the temperature of the intake port 2a is effectively reduced. As a result, the heat of the intake port 2a is less likely to be transferred to the injector 6, and the temperature of the injector 6 is reduced, accordingly.

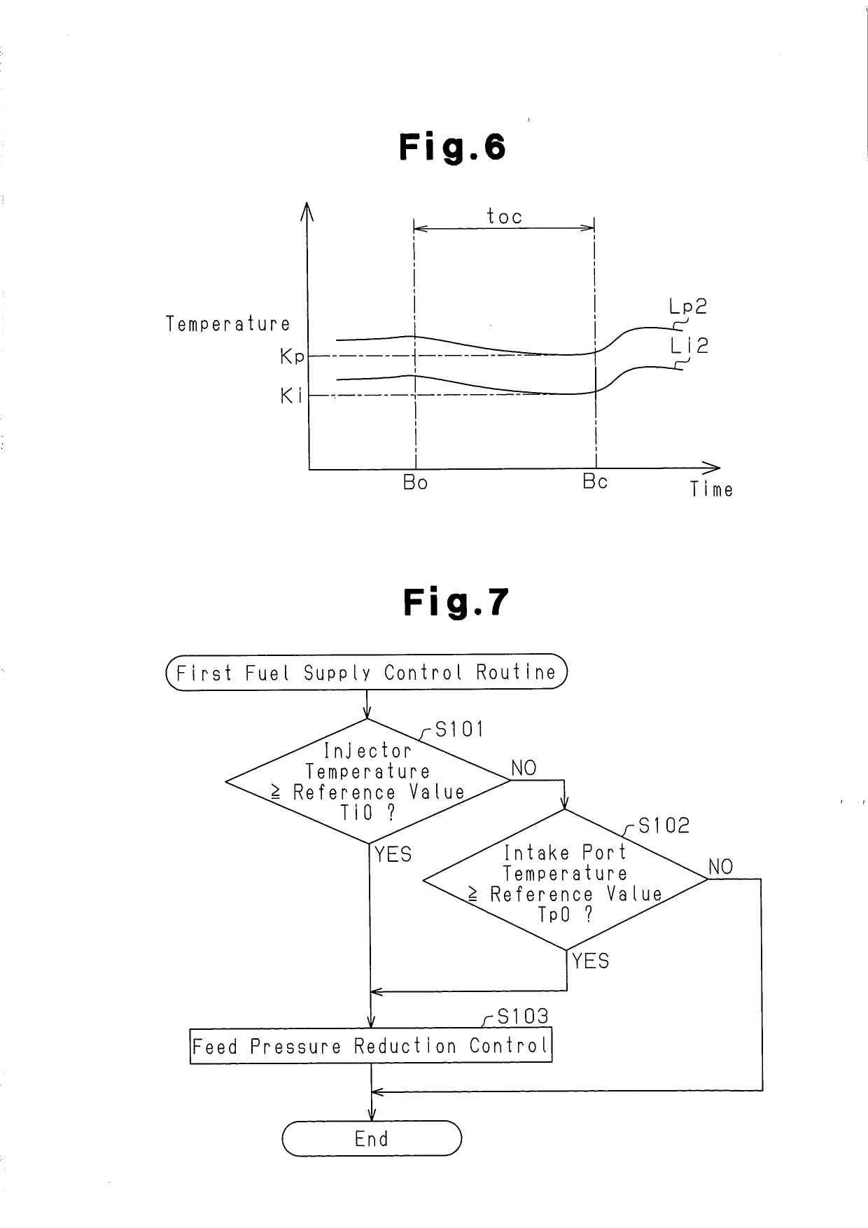

When the feed pressure is reduced, for example, from the value indicated by the point PH of FIG. 2 to the value indicated by the point PL by reducing the feed pressure by the above temperature reduction control during the execution of the normal feed pressure control, the fuel injection period in the injector 6 also becomes longer, in accordingly. Specifically, if a fuel injection period toc in the injector 6 is a period from a point in time Bo to a point in time Bc in FIGS. 5 and 6, the fuel injection period in the injector 6 becomes longer from the one shown in FIG. 5 to the one shown in FIG. 6 by reducing the feed pressure from the value indicated by the point PH of FIG. 2 to the value indicated by the point PL. If the fuel injection period in the injector 6 increases in this way, the fuel passes through the injector 6 over a longer period when being injected from the injector 6 and the injector 6 is effectively cooled by that fuel. The temperature of the injector 6 is reduced through such cooling of the injector 6 by the fuel.

Solid line Lp1 of FIG. 5 and solid line Lp2 of FIG. 6 each show temperature changes of the intake port 2a, and the temperature of the intake port 2a is reduced from a state shown by solid line Lp1 (FIG. 5) to a state shown by solid line Lp2 (FIG. 6) by a reduction of the feed pressure in the above temperature reduction control. Further, solid line Li1 of FIG. 5 and solid line Li2 of FIG. 6 each show temperature changes of the injector 6, and the temperature of the injector 6 is reduced from a state shown by solid line Li1 of FIG. 5 to a state shown by solid line Li2 of FIG. 6 by the above reduction of the feed pressure and the associated increase of the fuel injection period in the injector 6. On vertical axes of FIGS. 5 and 6, a value Kp indicates the lowest value of the temperature of the intake port 2a reduced through the above temperature reduction control and a value Ki indicates a lowest value of the temperature of the injector 6 reduced through the above temperature reduction control.

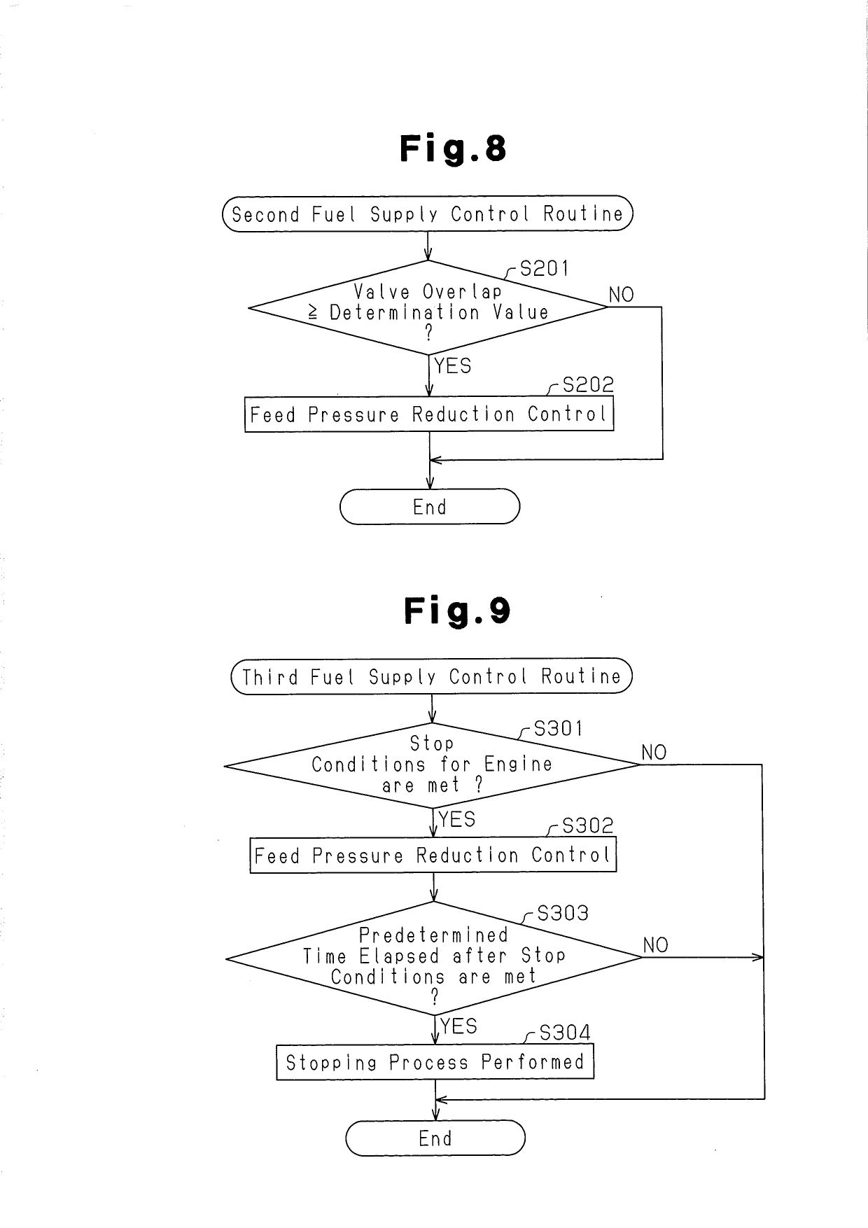

Next, detailed execution procedures of the above temperature reduction control are described with reference to a flowchart of FIG. 7 showing a first fuel supply control routine, a flowchart of FIG. 8 showing a second fuel supply control routine and a flowchart of FIG. 9 showing a third fuel supply control routine. These fuel supply control routines are periodically executed, for example, as an interrupt at predetermined time intervals through the electronic control device 16.

In the first fuel supply control routine of FIG. 7, it is determined whether the temperature of the injector 6 is higher than or equal to a reference value Ti0 (S101), and it is determined whether the temperature of the intake port 2a is higher than or equal to a reference value Tp0 (S102). Estimated values estimated from the engine operating conditions such as the cooling water temperature of the engine 1, the engine speed and the engine load can be employed as the temperature of the injector 6 and that of the intake port 2a. Since the vicinity of the nozzle of the injector 6 is exposed to heat from the intake port 2a when the temperature of the intake port 2a increases, the vicinity of the nozzle is placed in a high-temperature environment and deposit is more likely to be formed around the nozzle. Further, also when the temperature of the injector 6 increases and heat of the injector 6 itself is transferred to the vicinity of the nozzle, the vicinity of the nozzle is placed in a high-temperature environment and deposit is more likely to be formed around the nozzle. The reference values Ti0 and Tp0 used in S101 and S102 are respectively values corresponding to the temperatures of the injector 6 and the intake port 2a at which deposit is possibly formed around the nozzle of the injector 6 and values obtained in advance through experimentation or the like are employed.

If a determination result is affirmative in either one of S101 and S102, a feed pressure reduction control is performed for making the feed pressure in supplying the fuel adjusted to the feed pressure to the injector 6 lower than in the case of adjusting the feed pressure through the normal feed pressure control (S103). This feed pressure reduction control is performed as the above temperature reduction control to reduce the temperature of the injector 6. In this feed pressure reduction control, the feed pressure may be reduced by a reduction amount D from the feed pressure in the case of performing the normal feed pressure control. A fixed value determined as an optimal value in advance through experimentation or the like or a variable value that varies according to the engine operating conditions and the like can be employed as the above reduction amount D. Further, if the feed pressure is reduced through such a feed pressure reduction control, the fuel injection period of the injector 6 becomes longer, accordingly. The temperatures of the intake port 2a and the injector 6 are reduced by the feed pressure reduction and the increase of the fuel injection period. If the temperatures of the intake port 2a and the injector 6 are reduced in this way, the vicinity of the nozzle of the injector 6 is less likely to be placed in a high-temperature environment by in accordance with reduction in heat transfer from the intake port 2a to the injector 6. Therefore, the formation of deposit around the nozzle of the injector 6 is suppressed.

In the second fuel supply control routine of FIG. 8, it is first determined whether a valve overlap between the intake valve 25 and the exhaust valve 26 is greater than or equal to a determination value (S201). The above valve overlap can be obtained based on a signal from the crank position sensor 20 and a signal from the cam position sensor 21. If the valve overlap between the intake valve 25 and the exhaust valve 26 increases, the amount of exhaust gas flowing back from the combustion chamber 3 to the intake port 2a increases and the temperature of the intake port 2a and that of the injector 6 tend to increase due to heat of the exhaust gas, i.e. deposit tends to be formed around the nozzle of the injector 6. The determination value used in S201 is a value equivalent to a valve overlap at which deposit is possibly formed around the nozzle of the injector 6 and a value obtained in advance through experimentation or the like is employed. If a determination result is affirmative in S201, the feed pressure reduction control is performed as described above (S202). The feed pressure reduction control is also performed as the temperature reduction control for reducing the temperature of the injector 6. By a reduction of the feed pressure and an increase of the fuel injection period in the injector 6 caused by the execution of the above feed pressure reduction control, the temperatures of the intake port 2a and the injector 6 are reduced and, consequently, the formation of deposit around the nozzle of the injector 6 is suppressed.

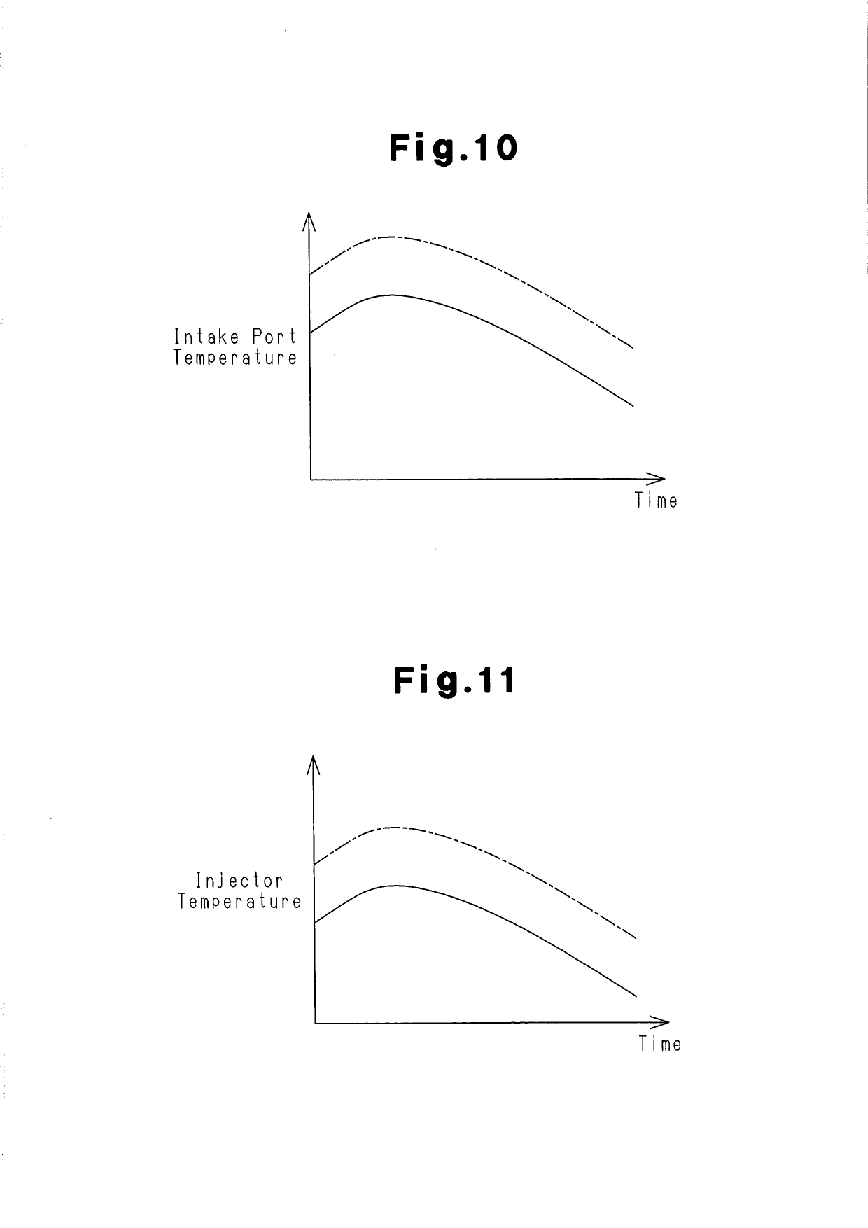

In the third fuel supply control routine of FIG. 9, it is first determined whether the stop conditions for the engine 1 in the intermittent operation of the engine 1 are met (S301). Immediately after the completion of the stopping operation of the engine 1, which has been initiated when the stop conditions for the engine 1 was met, a cooling function by the cooling water of the engine 1 does not work with a high temperature state of the engine 1 maintained. Thus, the temperature of the engine 1 further increases. At this time, heat of the engine 1 itself is transferred to the intake port 2a and the injector 6, whereby the temperature of the intake port 2a tends to increase, for example, as shown by a line formed by a long dash alternating with a short dash in FIG. 10, and the temperature of the injector 6 tends to increase, for example, as shown by a line formed by a long dash alternating with a short dash in FIG. 11. In other words, deposit tends to be formed around the nozzle of the injector 6 when the temperature of the intake port 2a and the injector 6 tends to increase. Thus, if a determination result is affirmative in S301 of FIG. 9, the feed pressure reduction control is performed as described above (S302). This feed pressure reduction control is also performed as the temperature reduction control for reducing the temperature of the injector 6. By a reduction of the feed pressure and an increase of the fuel injection period in the injector 6 caused by the execution of the above feed pressure reduction control, the temperature of the intake port 2a is reduced as shown by a solid line in FIG. 10 and the temperature of the injector 6 is reduced as shown by a solid line in FIG. 11. As a result, the formation of deposit around the nozzle of the injector 6 is suppressed.

After the feed pressure reduction control is performed as a processing of S302 of FIG. 9, it is determined whether a predetermined time has elapsed after the stop conditions for the engine 1 are met (S303). The predetermined time used here is, for example, set at a time necessary to reduce the temperature of the injector 6 through the execution of the feed pressure reduction control. If a determination result is affirmative in S303, a stopping process for stopping the engine 1 is performed (S304). Specifically, the operation of the engine 1 is stopped by stopping fuel injection from the injector 6.

The feed pressure is adjusted through the normal feed pressure control when the feed pressure reduction control (S103 of FIG. 7, S202 of FIG. 8, S302 of FIG. 9) is not performed in any one of the first to third fuel supply control routines.

According to this embodiment described in detail above, the following advantages are obtained.

(1) By performing the temperature reduction control through the first to third fuel supply control routines to reduce the temperature of the injector 6, heat transfer to the vicinity of the nozzle of the injector 6 is reduced. Since the vicinity of the nozzle of the injector 6 is less likely to be placed in a high-temperature environment in accordance with reduction in heat transfer to the vicinity of the nozzle of the injector 6, the formation of deposit around the nozzle of the injector 6 is suppressed.

(2) The feed pressure reduction control for making the feed pressure in supplying the fuel adjusted to the feed pressure to the injector 6 lower than in the case of adjusting the feed pressure through the normal feed pressure control is specifically performed as the above temperature reduction control for reducing the temperature of the injector 6. Since the particle size of the atomized fuel injected from the nozzle of the injector 6 becomes larger by reducing the feed pressure by this feed pressure reduction control, the particles of the fuel are more likely to reach the intake port 2a. When the particles of the atomized fuel reach the intake port 2a and are vaporized there, heat is absorbed from the intake port 2a through latent heat of vaporization of the fuel, whereby the temperature of the intake port 2a is effectively reduced. As a result, the heat of the intake port 2a is less likely to be transferred to the injector 6, and the temperature of the injector 6 can be reduced, accordingly.

(3) As the feed pressure is reduced by the above feed pressure reduction control, the fuel injection period in the injector 6 becomes longer. This increase of the fuel injection period is also performed as the temperature reduction control for reducing the temperature of the injector 6. If the fuel injection period in the injector 6 becomes longer as described above, the fuel passes through the injector 6 over a longer period in injecting the fuel from the injector 6 and the injector 6 is effectively cooled by that fuel. The temperature of the injector 6 can be reduced through such cooling of the injector 6 by the fuel.

The above embodiment may also be modified, for example, as follows.

The above temperature reduction control for reducing the temperature of the injector 6 may be performed on the condition that at least one of the parameters such as the cooling water temperature of the engine 1, the engine speed and the engine load becomes equal to or higher than a determination value set for each of the parameters. Specifically, the feed pressure reduction control in the first to third fuel supply control routines is performed when the above condition is met. If the parameters such as the cooling water temperature of the engine 1, the engine speed and the engine load are high values, the temperature of the injector 6 tends to increase. Thus, by performing the above temperature reduction control (feed pressure reduction control) when the above condition is met, the temperature of the injector 6 can be reduced in a situation where the temperature of the injector 6 tends to increase.

The present invention may be applied to an engine that performs a fuel injection control in which the fuel injection time in the injector 6 is fixed regardless of the feed pressure. In this case, a reduction of the feed pressure and an increase of the fuel injection period can be individually performed as the temperature reduction control for reducing the temperature of the injector 6. Thus, it becomes possible only to reduce the feed pressure or only to increase the fuel injection period as the above temperature reduction control.

The temperature of the injector 6 and that of the intake port 2a used in the first fuel supply control routine may be actual measurement values given by sensors or the like.

In the first fuel supply control routine, the feed pressure reduction control may be performed when the temperature of the injector 6 is higher than or equal to the reference value Ti0 regardless of the temperature of the intake port 2a or when the temperature of the intake port 2a is higher than or equal to the reference value Tp0 regardless of the temperature of the injector 6.

Only one of the first to third fuel supply control routines may be executed or any two of the respective routines may be executed.

In the third fuel supply control routine, in initiating the stopping operation of the engine 1, the feed pressure reduction control is performed as the temperature reduction control for reducing the temperature of the injector 6 before the initiation of the stopping operation. The stopping operation of the above engine 1 may be not only an automatic stop during the intermittent operation, but also a stop based on a stopping operation by the driver of the automobile.

The present invention may also be applied to an engine including an injector for injecting fuel toward an intake port and an injector for directly injecting fuel into a combustion chamber.

### DESCRIPTION OF THE REFERENCE NUMERALS

1 . . . engine, 2 . . . intake passage, 2a. . . intake port, 3 . . . combustion chamber, 4 . . . throttle valve, 5 . . . accelerator pedal, 6 . . . injector, 7 . . . fuel supply device, 8 . . . fuel tank, 9 . . . feed pump, 10 . . . starter, 11 . . . variable valve timing mechanism, 12 . . . spark plug, 13 . . . piston, 14 . . . crankshaft, 15 . . . exhaust passage, 16 . . . electronic control device, 17 . . . accelerator position sensor, 18 . . . throttle position sensor, 19 . . . air flow meter, 20 . . . crank position sensor, 21 . . . cam position sensor, water temperature sensor, 23 . . . pressure sensor, 25 . . . intake valve, 26 . . . exhaust valve, 27 . . . intake camshaft, 28 . . . exhaust camshaft, 31 . . . fuel pipe, 32 . . . pressure regulator.

1. A fuel supply device for an internal combustion engine, the fuel supply device supplying fuel adjusted to a feed pressure to an injector for injecting the fuel into an intake port, the device comprising:
a controller for performing a fuel supply control to supply fuel to the injector, wherein,
when temperature of the intake port or the injector becomes higher than a reference value, the controller performs, as the fuel supply control, a temperature reduction control for reducing the temperature of the injector and
the controller reduces the feed pressure or increases a fuel injection period of the injector through the temperature reduction control.

2. (canceled)

3. A fuel supply device for an internal combustion engine, the fuel supply device supplying fuel adjusted to a feed pressure to an injector for injecting the fuel into an intake port, the device comprising:
a controller for performing a fuel supply control to supply fuel to the injector,
wherein, when a valve overlap between an intake valve and an exhaust valve of the internal combustion engine is larger than a predetermined value, the controller performs, as the fuel supply control, a temperature reduction control for reducing temperature of the injector.

4. The fuel supply device for an internal combustion engine according to claim 3, wherein the controller reduces the feed pressure through the temperature reduction control.

5. The fuel supply device for an internal combustion engine according to claim 3, wherein the controller increases a fuel injection period of the injector through the temperature reduction control.

6. A fuel supply device for an internal combustion engine, the fuel supply device supplying fuel adjusted to a feed pressure to an injector for injecting the fuel into an intake port, the device comprising:
a controller for performing a fuel supply control to supply fuel to the injector, wherein
when initiating a stopping process of the internal combustion engine, the controller performs, as the fuel supply control, a temperature reduction control for reducing temperature of the injector prior to the initiation of the stopping process, and
when a stop condition in an intermittent operation of the engine is met, the controller performs the temperature reduction control, and the controller performs the stopping process for stopping the engine after performing the temperature reduction control.

7. A fuel supply device for an internal combustion engine, the fuel supply device supplying fuel adjusted to a feed pressure to an injector for injecting the fuel into an intake port, the device comprising:
a controller for performing a fuel supply control to supply fuel to the injector, wherein
when initiating a stopping process of the internal combustion engine, the controller performs, as the fuel supply control, a temperature reduction control for reducing temperature of the injector prior to the initiation of the stopping process, and
the controller reduces the feed pressure or increases a fuel injection period of the injector through the temperature reduction control.

8. The fuel supply device for an internal combustion engine according to claim 1, wherein the controller performs the temperature reduction control on the condition that at least one of parameters including a cooling water temperature, a rotational speed and a load of the internal combustion engine is equal to or higher than a determination value set for each of the parameters.

9. The fuel supply device for an internal combustion engine according to claim 3, wherein the controller performs the temperature reduction control on the condition that at least one of parameters including a cooling water temperature, a rotational speed and a load of the internal combustion engine is equal to or higher than a determination value set for each of the parameters.

10. The fuel supply device for an internal combustion engine according to claim 6, wherein the controller performs the temperature reduction control on the condition that at least one of parameters including a cooling water temperature, a rotational speed and a load of the internal combustion engine is equal to or higher than a determination value set for each of the parameters.

11. The fuel supply device for an internal combustion engine according to claim 7, wherein the controller performs the temperature reduction control on the condition that at least one of parameters including a cooling water temperature, a rotational speed and a load of the internal combustion engine is equal to or higher than a determination value set for each of the parameters.
